(19) United States
(12) Patent Application Publication
(10) Pub. No.: US 2010/0102735 A1
(43) Pub. Date: Apr. 29, 2010

(54) LED LIGHT STRING WITH ZENER DIODES OR RESISTORS AS SHUNTS

(76) Inventors: Chu-Cheng CHANG, Hsinchu City (TW); Cheng-Fen Chang, Hsinchu City (TW); Chen-Hsien Chang, Hsinchu City (TW); Chen-Tao Chang, Hsinchu City (TW)

Correspondence Address: BIRCH STEWART KOLASCH & BIRCH, PO BOX 747, FALLS CHURCH, VA, 22040-0747, US

(21) Appl. No.: 12/260,738

(22) Filed: Oct. 29, 2008

(51) Int. Cl. H05B 37/00

(52) U.S. Cl. 315/192

(57) ABSTRACT

A light string in one embodiment includes a plurality of lamps connected in series, each lamp having a shunt Zener diode; and a rectifier. An anode of the Zener diode of each lamp is connected to a cathode of the LED thereof, the cathode of the Zener diode of each lamp is connected to the anode of the LED thereof, the cathode of the Zener diode of the lamp proximate the rectifier is connected to a positive terminal of an output of the rectifier, and the anode of the Zener diode of the lamp distal the rectifier is connected to a negative terminal of the output of the rectifier. The Zener diodes are replaced by resistors in another embodiment. Hence, a burned out LED of one lamp will not adversely affect a normal operation of the light string.

### BACKGROUND OF THE INVENTION

1. Field of Invention

The invention relates to providing electrical power to a plurality of low voltage electrical loads, and more particularly to a string of LED (light-emitting diode) light having a plurality of lamps arranged in series, each lamp having a shunt Zener diode or resistor so that a burned out LED of one lamp will not adversely affect a normal operation of the light string.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

A typical string of lights including a plurality of LED bulbs arranged electrically in a series circuit is shown in FIG. 1. AC (alternating current) 120V is rectified by a full-wave rectifier (e.g., bridge rectifier) to convert into DC (direct current) to be consumed by the plurality of LED bulbs. However, the well known light string suffers from a disadvantage. In detail, one LED bulb of the string burning out will kill the circuit. For example, the light string comprises 40 blue LED bulbs of 3V 0.02 A. Any burned out blue LED bulb will kill the circuit with the remaining 39 blue LED bulbs being disabled.

Another typical string of lights including a plurality of (e.g., 35) white LED bulbs of 3.2V 0.02 A arranged electrically in a parallel circuit is shown in FIG. 2. It has the advantage of maintaining the circuit in a normal operation except all LED bulbs are burned out. That is, for example, one burned out LED bulb will not kill the circuit. However, the well known light string still suffers from a disadvantage. In detail, electric current is required to increase as the number of LED bulbs increases. The total current (e.g., I) of the circuit can be expressed as a multiplication of current (e.g., I_{f}) flowing through each LED bulb times the number of LED bulbs (e.g., N). As shown, AC 120V is rectified by a full-wave rectifier 11 to convert into DC (e.g., DC 3.5V 0.7 A) to be consumed by the 35 white LED bulbs. For example, operating voltage of the white LED bulb is 3.2V and operating current thereof is 0.7 A. Hence, the total current (I) is 0.02 A×35 equal to 0.7 A. Advantageously, the circuit will maintain its normal operation if, for example, one white LED bulb is burned out. That is, the remaining 34 white LED bulbs still emit light. This parallel circuit requiring low voltage (e.g., DC 3.5V) and high current (e.g., 0.7 A), however, is very difficult to design. And in turn, it can greatly increase the manufacturing cost.

There have been numerous suggestions in prior patents for light string. For example, U.S. Pat. No. 6,344,716 discloses a Christmas light string. Thus, continuing improvements in the exploitation of light string employing LED bulbs are constantly being sought.

### SUMMARY OF THE INVENTION

It is therefore one object of the invention to provide a light string comprising a plurality of lamps connected in series, each lamp having a shunt Zener diode or resistor so that a burned out LED of one lamp will not adversely affect a normal operation of the light string.

The above and other objects, features and advantages of the invention will become apparent from the following detailed description taken with the accompanying drawings.

### BRIEF DESCRIPTION OF THE DRAWINGS

FIG. 1 is a circuit diagram of a typical LED light string with lamps arranged in series;

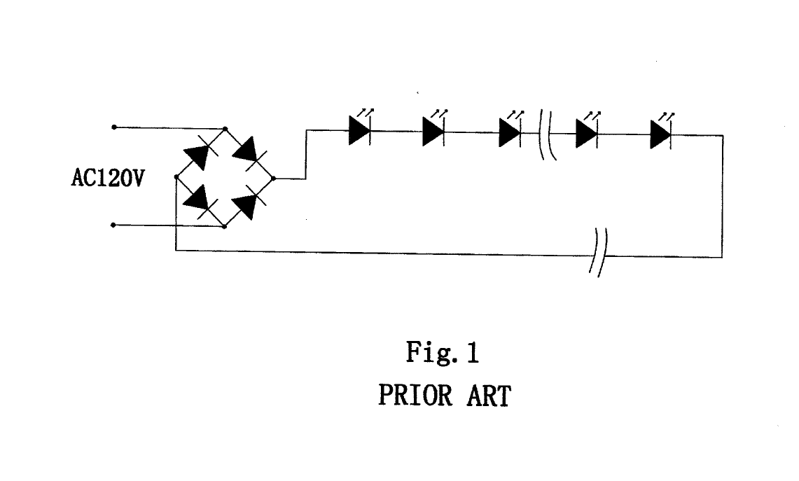

FIG. 2 is a circuit diagram of another typical LED light string with lamps arranged in parallel;

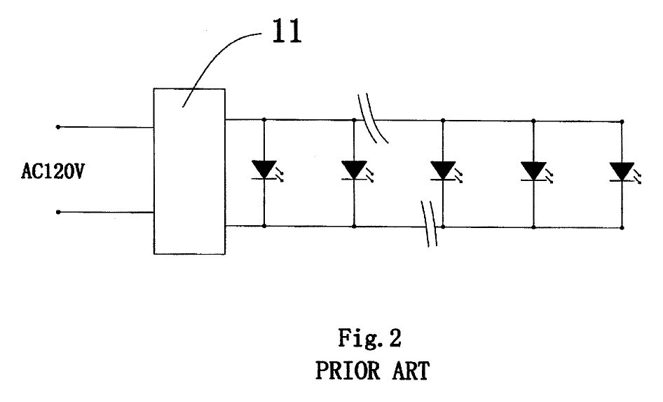

FIG. 3 is a schematic circuit diagram of a string of lights according to the invention;

FIG. 4 is a circuit diagram of a first preferred embodiment of rectifier according to the invention;

FIG. 5 is a circuit diagram of a second preferred embodiment of rectifier according to the invention;

FIG. 6 is a circuit diagram of a third preferred embodiment of rectifier according to the invention;

FIG. 7 is an illustration of a first preferred embodiment of string of lights according to the invention;

FIG. 8 is an enlarged view of the lamp of FIG. 7;

FIG. 9 is a circuit diagram of the first preferred embodiment of string of lights incorporating the first preferred embodiment of rectifier according to the invention;

FIG. 10 is a circuit diagram of the first preferred embodiment of the string of lights incorporating the second preferred embodiment of rectifier according to the invention;

FIG. 11 is a circuit diagram of the first preferred embodiment of the string of lights incorporating the third preferred embodiment of rectifier according to the invention;

FIG. 12 is an illustration of a second preferred embodiment of string of lights according to the invention;

FIG. 13 is an enlarged view of the lamp of FIG. 12;

FIG. 14 is a circuit diagram of the second preferred embodiment of string of lights incorporating the first preferred embodiment of rectifier according to the invention;

FIG. 15 is a circuit diagram of the second preferred embodiment of the string of lights incorporating the second preferred embodiment of rectifier according to the invention; and

FIG. 16 is a circuit diagram of the second preferred embodiment of the string of lights incorporating the third preferred embodiment of rectifier according to the invention.

### DETAILED DESCRIPTION OF THE INVENTION

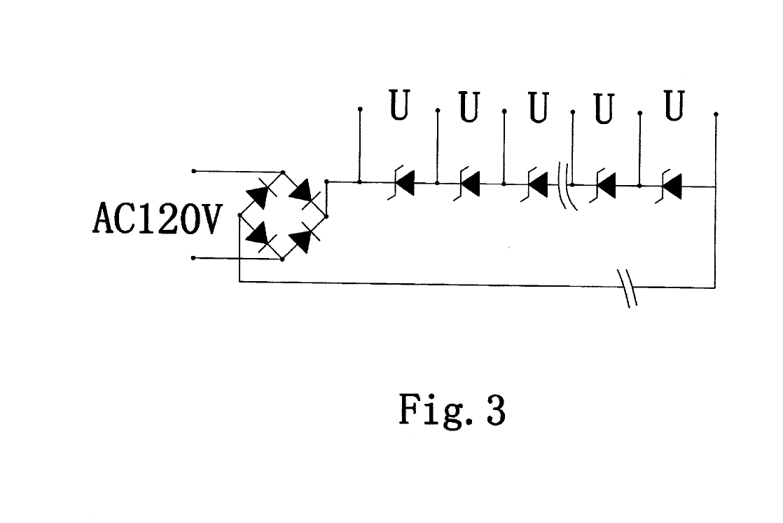

Referring to FIG. 3, a schematic circuit diagram of a string of lights according to the invention is shown. As shown, AC input is AC 120V and the string of lights comprises a plurality of lamps U.

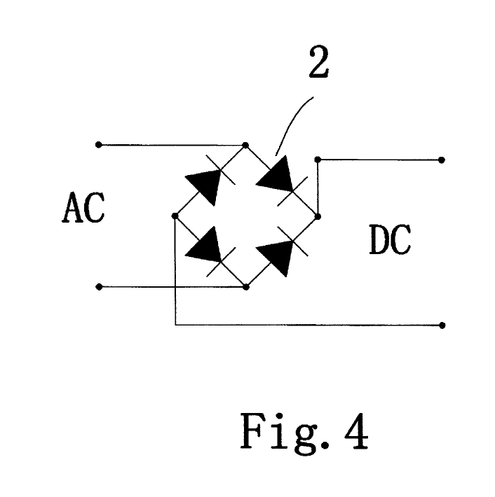

Referring to FIG. 4, a first preferred embodiment of rectifier 2 according to the invention is shown. The rectifier 2 is implemented as a full-wave rectifier (e.g., bridge rectifier). The rectifier 2 comprises two pairs of diodes and is adapted to convert AC 120V into DC 120V (i.e., operating voltage) to be consumed by a plurality of lamps of the string of lights.

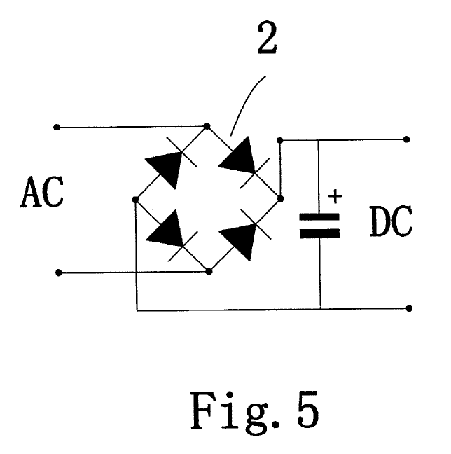

Referring to FIG. 5, a second preferred embodiment of rectifier 2 according to the invention is shown. The rectifier 2 is implemented as a full-wave rectifier (e.g., bridge rectifier) and a capacitor is inserted in parallel with the load (i.e., the lamps U). The capacitor has the function of offering almost infinite impedance to the DC current. Consequently almost all of the DC current flows through the load. As a result, the current waveshape is smoothed out.

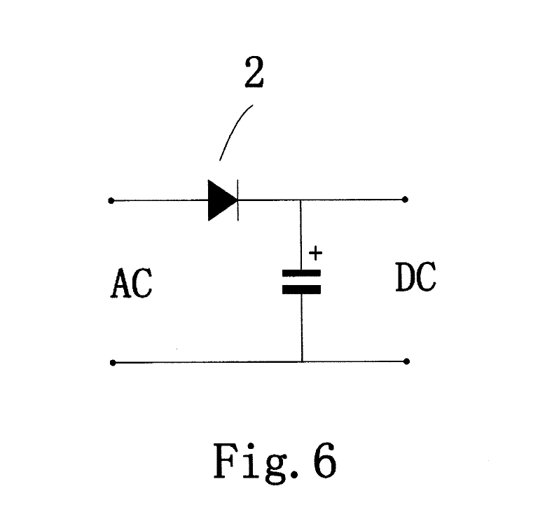

Referring to FIG. 6, a third preferred embodiment of rectifier 2 according to the invention is shown. The rectifier 2 is implemented as a half-wave rectifier and a capacitor is inserted in parallel with the load (i.e., the lamps U). The capacitor has the function of offering almost infinite impedance to the DC current. Consequently, almost all of the DC current flows through the load. As a result, the current waveshape is smoothed out.

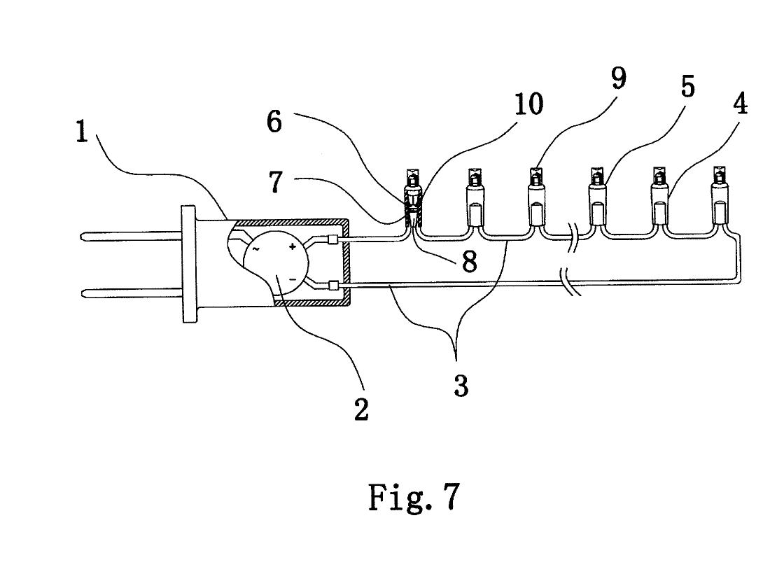

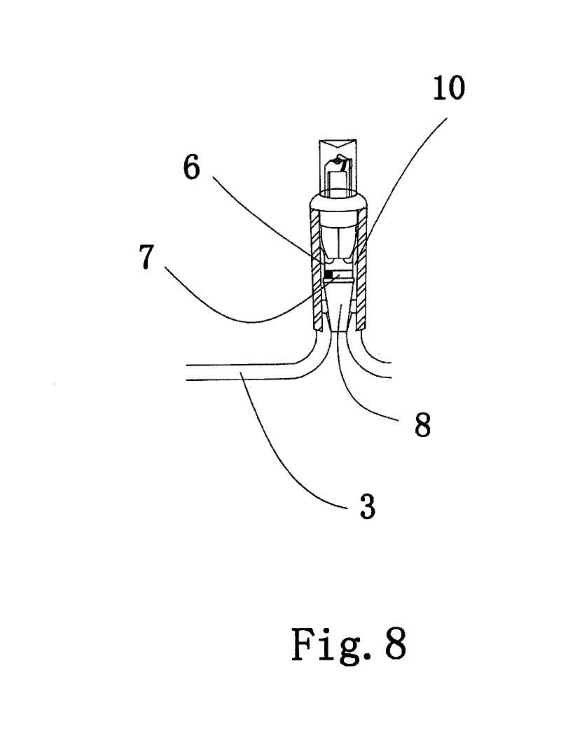

Referring to FIGS. 7 and 8, a first preferred embodiment of light string comprises a plug 1 having positive and negative prongs (not numbered), a rectifier 2 as any one shown above, and a plurality of lamps 4 electrically connected together between positive terminal of the rectifier 2 and negative terminal thereof through a cord 3 to construct a complete circuit. Each lamp 4 comprises a seat 8, a first contact 6 connected to one end of a section of the cord 3, a second contact 10 connected to one end of another section of the cord 3, a Zener diode 7 secured onto the seat 8 and interconnecting the contacts 6, 10, a top cap 5 formed of flexible material, and an exposed LED 9 secured onto the cap 5 and interconnecting the contacts 6, 10.

The cathode of the Zener diode 7 of the lamp 4 proximate the rectifier 2 is connected to the positive terminal of the rectifier output and the anode of the Zener diode 7 of the lamp 4 distal the rectifier 2 is connected to the negative terminal of the rectifier output. The LED 9 is in parallel with the Zener diode 7 with the anode of the Zener diode 7 connected to the cathode of the LED 9 and the cathode of the Zener diode 7 connected to the anode of the LED 9. For the circuit, the Zener diodes 7 are connected in series and the LEDs 9 also are connected in series.

The Zener diode 7 of the lamp 4 is used as a voltage stabilizer for the LED 9 thereof. Hence, only low current in a safe range flows through the LEDs 9. As a result, the LEDs 2 can operate normally for a prolonged period of time. Hence, the life time of the light string is prolonged greatly.

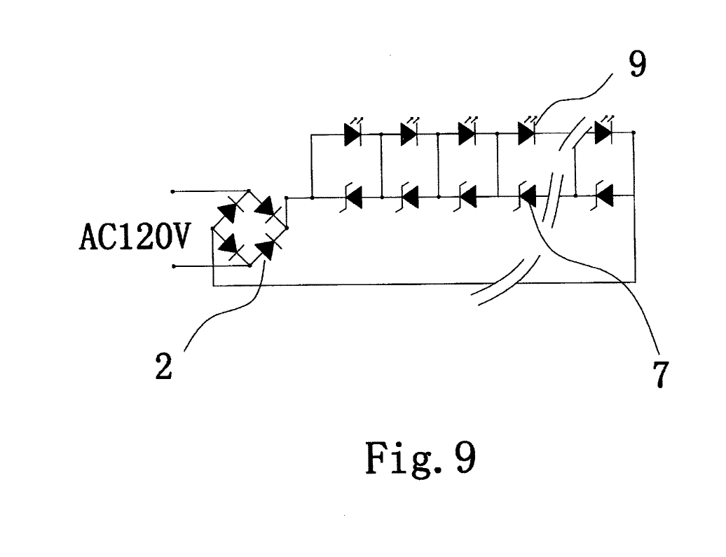

Referring to FIG. 9, it shows a circuit diagram of the first preferred embodiment of the string of lights incorporating the first preferred embodiment of rectifier 2 according to the invention. The load of the circuit (i.e., the string of lights), i.e., the plurality of LEDs 9 and the plurality of Zener diodes 7 as arranged above, is coupled to the rectifier output. The rectifier 2 is adapted to convert AC 120V into DC 120V. In this embodiment, the Zener diode 7 has a breakdown voltage of 5V in the reverse direction. Breakdown voltage of 5V is equal to or larger than an operating voltage of LED 9. The LEDs 9 are adapted to emit white light and have an operating current of 0.02 A. Advantageously the current will bypass any burned out LED 9 to flow through its parallel Zener diode 7 (i.e., shunt). Hence, the circuit still maintain in a normal operation.

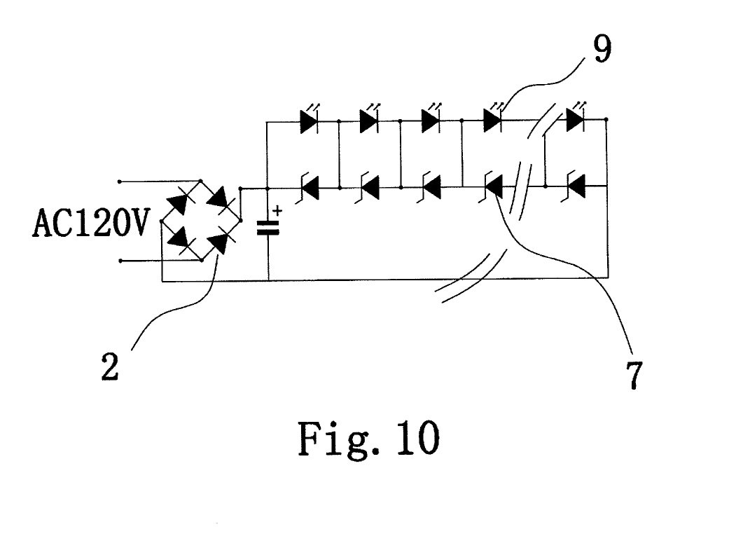

Referring to FIG. 10, it shows a circuit diagram of the first preferred embodiment of the string of lights incorporating the second preferred embodiment of rectifier according to the invention. The characteristics of the second preferred embodiment are detailed below. Waveshape of rectifier output is more smooth due to the provision of the capacitor. The Zener diode 7 has a breakdown voltage of 8V in the reverse direction. Breakdown voltage of 8V is equal to or larger than an operating voltage of LED 9. The LEDs 9 are adapted to emit blue light and have an operating current of 0.02 A. Advantageously, the current will bypass any burned out LED 9 to flow through its parallel Zener diode 7 (i.e., shunt). Hence, the circuit still maintain in a normal operation.

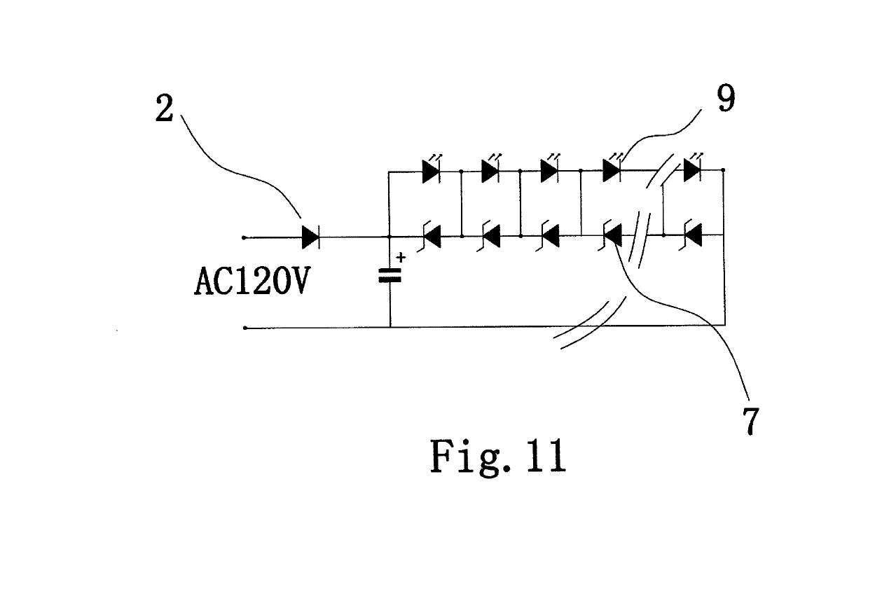

Referring to FIG. 11, it shows a circuit diagram of the first preferred embodiment of the string of lights incorporating the third preferred embodiment of rectifier according to the invention. The characteristics of the third preferred embodiment are detailed below. Waveshape of rectifier output is more smooth due to the provision of the capacitor. The Zener diode 7 has a breakdown voltage of 12V in the reverse direction. Breakdown voltage of 12V is equal to or larger than an operating voltage of LED 9. The LEDs 9 are adapted to emit red light and have an operating current of 0.02 A. Advantageously, the current will bypass any burned out LED 9 to flow through its parallel Zener diode 7 (i.e., shunt). Hence, the circuit still maintain in a normal operation.

Note that one or more of the LEDs 9 can be replaced with LEDs capable of flashing in other embodiments so that the light string can be more attractive in use.

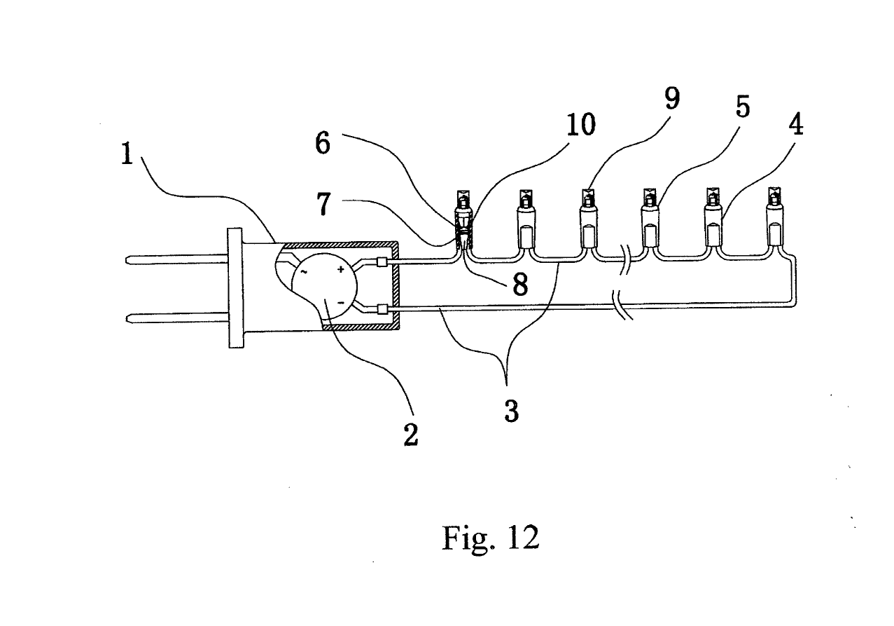

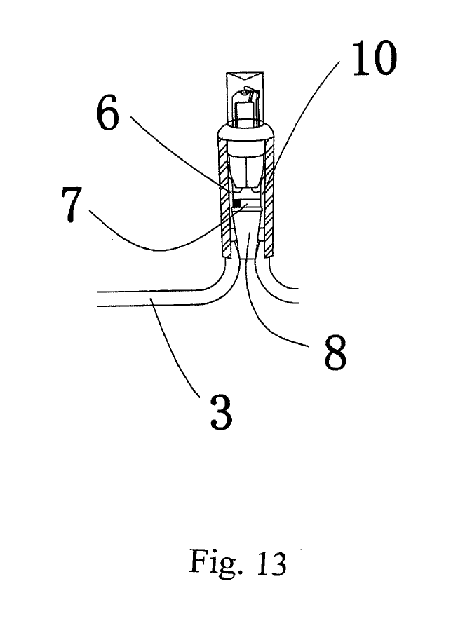

Referring to FIGS. 12 and 13, a second preferred embodiment of light string comprises a plug 1 having positive and negative prongs (not numbered), a rectifier 2 implemented as any one shown above, and a plurality of lamps 4 electrically connected together between positive terminal of the rectifier 2 and negative terminal thereof through a cord 3 to construct a complete circuit. Each lamp 4 comprises a seat 8, a first contact 6 connected to one end of a section of the cord 3, a second contact 10 connected to one end of another section of the cord 3, a resistor 7 secured onto the seat 8 and interconnecting the contacts 6, 10, a top cap 5 formed of flexible material, and an exposed LED 9 secured onto the cap 5 and interconnecting the contacts 6, 10.

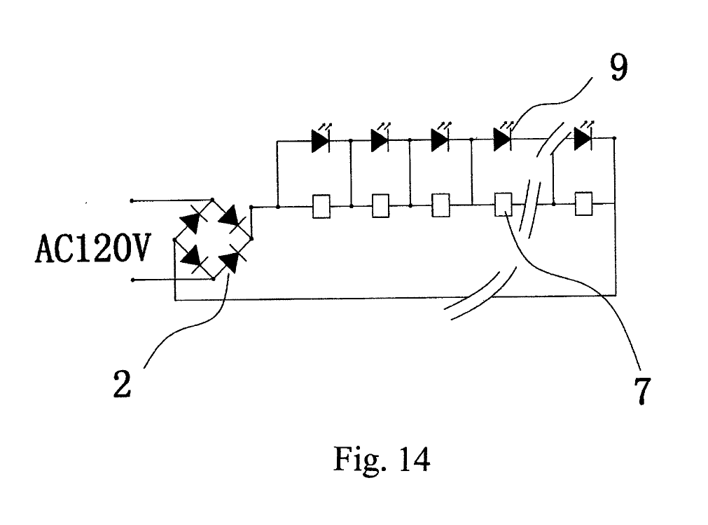

Referring to FIG. 14, it shows a circuit diagram of a second preferred embodiment of the string of lights incorporating the first preferred embodiment of rectifier 2 according to the invention. The load of the circuit (i.e., the string of lights), i.e., the plurality of LEDs 9 and the plurality of resistors 7 as arranged above, is coupled to the rectifier output. The rectifier 2 is adapted to convert AC 120V into DC 120V. In this embodiment, the resistor 7 has a resistance of 400Ω and a voltage equal to an operating voltage of LED 9. The LEDs 9 are adapted to emit white light and have an operating current of 0.02 A. Advantageously, the current will bypass any burned out LED 9 to flow through its parallel resistor 7 (i.e., shunt). Hence, the circuit still maintain in a normal operation.

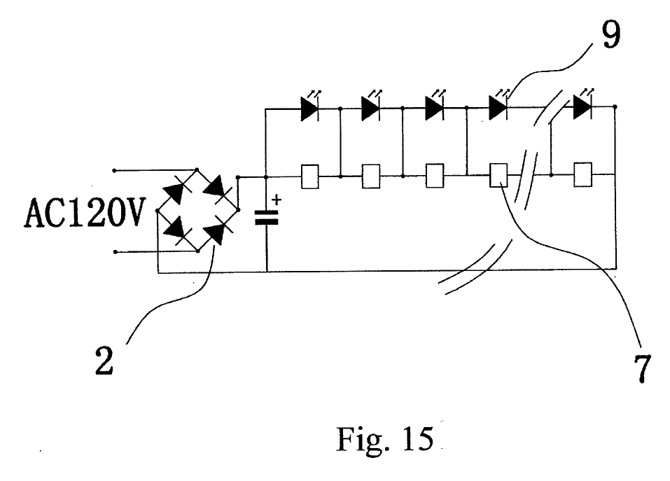

Referring to FIG. 15, it shows a circuit diagram of the second preferred embodiment of string of lights incorporating the second preferred embodiment of rectifier according to the invention. Waveshape of rectifier output is more smooth due to the provision of the capacitor. The resistor 7 has a resistance of 400Ω and a voltage equal to an operating voltage of LED 9. The LEDs 9 are adapted to emit blue light and have an operating current of 0.02 A. Advantageously, the current will bypass any burned out LED 9 to flow through its parallel resistor 7 (i.e., shunt). Hence, the circuit still maintain in a normal operation.

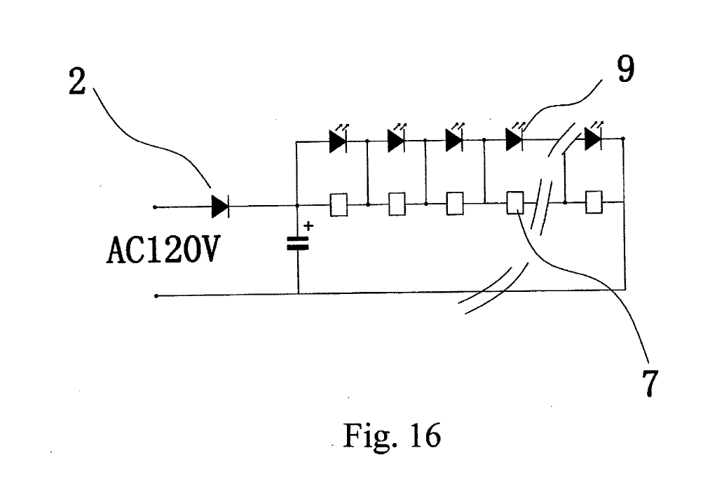

Referring to FIG. 16, it shows a circuit diagram of the second preferred embodiment of the string of lights incorporating the third preferred embodiment of rectifier according to the invention. Waveshape of rectifier output is more smooth due to the provision of the capacitor. The resistor 7 has a resistance of 400Ω and a voltage equal to an operating voltage of LED 9. The LEDs 9 are adapted to emit red light and have an operating current of 0.02 A. Advantageously, the current will bypass any burned out LED 9 to flow through its parallel resistor 7 (i.e., shunt). Hence, the circuit still maintain in a normal operation.

Note that one or more of the LEDs 9 can be replaced with LEDs capable of flashing in other embodiments so that the light string can be more attractive in use.

While the invention herein disclosed has been described by means of specific embodiments, numerous modifications and variations could be made thereto by those skilled in the art without departing from the scope and spirit of the invention set forth in the claims.

What is claimed is:

1. An electrical circuit for use as a string of lights, comprising:
a plurality of lamps connected in series, the lamp comprising an LED and a Zener diode in parallel therewith; and
a rectifier for converting AC (alternating current) into DC (direct current),
wherein an anode of the Zener diode of each lamp is connected to a cathode of the LED thereof, the cathode of the Zener diode of each lamp is connected to the anode of the LED thereof, the cathode of the Zener diode of the lamp proximate the rectifier is connected to a positive terminal of an output of the rectifier, and the anode of the Zener diode of the lamp distal the rectifier is connected to a negative terminal of the output of the rectifier.

2. The electrical circuit of claim 1, wherein the rectifier is a bridge rectifier.

3. The electrical circuit of claim 1, wherein the rectifier is a bridge rectifier, the electrical circuit further comprising a capacitor inserted in parallel with the lamps.

4. The electrical circuit of claim 1, wherein the rectifier is a half-wave rectifier, the electrical circuit further comprising a capacitor inserted in parallel with the lamps.

5. The electrical circuit of claim 1, wherein the Zener diode of each lamp has a reverse breakdown voltage of 5V equal to or larger than an operating voltage of the LED thereof, and wherein the LEDs are adapted to emit white light and have an operating current of 0.02 A.

6. The electrical circuit of claim 1, wherein the Zener diode of each lamp has a reverse breakdown voltage of 8V equal to or larger than an operating voltage of the LED thereof, and wherein the LEDs are adapted to emit blue light and have an operating current of 0.02 A.

7. The electrical circuit of claim 1, wherein the Zener diode of each lamp has a reverse breakdown voltage of 12V equal to or larger than an operating voltage of the LED thereof, and wherein the LEDs are adapted to emit red light and have an operating current of 0.02 A.

8. An electrical circuit for use as a string of lights, comprising:
a plurality of lamps connected in series, the lamp comprising an LED and a resistor in parallel therewith; and
a rectifier for converting AC (alternating current) into DC (direct current).

9. The electrical circuit of claim 8, wherein the rectifier is a bridge rectifier.

10. The electrical circuit of claim 8, wherein the rectifier is a bridge rectifier, the electrical circuit further comprising a capacitor inserted in parallel with the lamps.

11. The electrical circuit of claim 8, wherein the rectifier is a half-wave rectifier, the electrical circuit further comprising a capacitor inserted in parallel with the lamps.

12. The electrical circuit of claim 8, wherein the LEDs are adapted to emit white light and have an operating current of 0.02 A.

13. The electrical circuit of claim 8, wherein the LEDs are adapted to emit blue light and have an operating current of 0.02 A.

14. The electrical circuit of claim 8, wherein the LEDs are adapted to emit red light and have an operating current of 0.02 A.
